(19) United States
(12) Patent Application Publication
(10) Pub. No.: US 2018/0303033 A1
(43) Pub. Date: Oct. 25, 2018

(54) PLANT STRIPPER

(71) Applicant: Michael John Jones, Colorado Springs, CO (US)

(72) Inventor: Michael John Jones, Colorado Springs, CO (US)

(21) Appl. No.: 15/954,585

(22) Filed: Apr. 16, 2018

Related U.S. Application Data
(60) Provisional application No. 62/485,827, filed on Apr. 14, 2017.

(51) Int. Cl. A01D 45/06; A01D 46/02

(52) U.S. Cl. CPC A01D 45/065; A01D 46/02

(57) ABSTRACT

A plant stripper is provided. The plant stripper, in one implementation includes a motor comprising a drive shaft; a first roller coupled to the drive shaft and configured to be turned by the motor; and a second roller opposing the first roller and defining a gap between the rollers for receiving a stem of a plant. A stripping guide element defines an opening disposed opposite the gap between the first and second roller. The opening is defined by a surface surrounding the opening and configured to contact plant material while allowing the stem to pass through the opening. The surface is configured to remove plant material from the stem as the stem is pulled through the opening by the first and second rollers.

### CROSS-REFERENCE TO RELATED APPLICATIONS

This application claims the benefit of U.S. provisional application No. 62/485,827, filed 14 Apr. 2017, which is hereby incorporated by reference in its entirety including all appendices thereto though fully set forth herein.

### BACKGROUND

### a. Field

The instant invention relates to a plant stripper for removing plant material, such as leaves, buds, flowers, and other items from a stem and, in some instances, discarding the stripped stem from the device.

### BRIEF SUMMARY

In one example implementation, a plant stripper configured to remove material from a stem of a plant, such but not limited to a hop, hemp or cannabis plant, is provided. In various implementations, for example, a plant material including a stem and one or more of leaves, buds, flowers, or the like are fed into an opening of the plant stripper device. The device comprises a pair of rollers, such as but not limited to gum rollers, disposed adjacent one another such that an end of the stem is received between the two rollers. In one example, the leaves, buds, flowers or the like get bunched so that when the stem is fed through the opening, it reaches the roller surfaces while the plant material (leaves, buds, flowers and the like) are stripped from the stem by a surface surrounding the opening through which the stem has been fed. In various implementations, the opening is sized and configured to receive the stem of the plant, but strip the remaining plant materials from the stem as the stem is pulled through the opening by the rollers. As the plant materials are stripped from the stem by the surface surrounding the opening, the plant materials are received in a box or other receptacle disposed below the opening under gravitational forces. In other implementations, one or more belts or other components may be used to direct the stripped plant material toward a receptacle for collection. The stripped stems, in turn, are discarded through the opposite side of the rollers and may also be received and captured by one or more other receptacles or may be discarded into a pile (e.g. on the ground) for later collection and disposal. Other plant material that proceeds through the opening is further compressed by the rollers (e.g., smashed into a residue) and falls onto a secondary collection device (e.g., a tray or shelf) as the stem is discarded. Thus, in some implementations, plant material removed from the stems may be collected in primary and secondary collection receptacles.

In one implementation, for example, a stripper configured for removing leaves and buds from hemp plant stems comprises a pair of two gum rubber rollers. The rollers, for example, may comprise two inch solid steel shafts covered with gum rubber approximately ½ inch thick. In some implementations, the two inch solid steel shaft acts as a flywheel so that the weight of the shaft keeps centrifugal force going, which in turn maintains the RPMs of the rollers. A belt driven pulley (or other drive mechanism) may be coupled to a hub that goes around the steel shaft. In some implementations, the hub may be secured by a one or more set screws although other connections are possible. The hub in turn may reduce the two inch diameter of the shaft to an approximately ¾ inch shaft on the hub which goes on a six inch shiv with the belt to drive the shaft of one of the rollers.

In one implementation, one of the rollers is driven and the other shaft is turned by the two gum rubbers held on a sealed bearing block (e.g., a two inch pillow block). A threaded coupling (e.g., a two inch all thread) may be used to couple with the bearing/pillow block to adjust the shafts to contact each other such that the driven roller powers the secondary roller. On an opposing end of the shaft, another threaded coupling (e.g., ¾ inch all thread) holds the pillow block and the shaft and can be used to adjust for variable sizes of holes and spacings between the rollers. Each gum rubber layer on the rollers flexes (e.g., approximately ¼ inch in some implementations) so that the device adjusts for variable sized stems. In some implementations, the gum rubber layers are soft enough to grip the stems but still hard enough to handle the tough hemp stem material.

In one implementation, a motor (e.g., a three-phase motor) has a drive shaft (e.g., a two inch shiv) that holds a V belt (e.g., an “A” sized belt). To provide a soft start to control the speed and start the motor to turn slowly an inverter may be used to control the motor drive frequency (e.g., slow down, speed up, reverse) under control of the inverter. This in turn can be used to stop the machine without damaging the rollers and/or to enable the rollers to be run in reverse.

The foregoing and other aspects, features, details, utilities, and advantages of the present invention will be apparent from reading the following description and claims, and from reviewing the accompanying drawings.

### BRIEF DESCRIPTION OF THE DRAWINGS

FIGS. 1A and 1B, respectively, show rear perspective (FIG. 1A) and front perspective (FIG. 1B) views of an example implementation of a plant stripper.

FIGS. 2A and 2B show perspective views of the plant stripper 10 shown in FIGS. 1A and 1B in a partially assembled configuration.

FIGS. 3A and 3B show further perspective views of the plant stripper shown in FIGS. 1A, 1B, 2A and 2B in a partially assembled configuration.

FIGS. 4A and 4B show perspective views of an assembled roller device of a plant stripper, such as shown in FIGS. 1A-3B and an unassembled roller device of a plant stripper, respectively.

FIGS. 6A-6C show example implementations of a threaded knob assembly for a plant stripper, such as the plant stripper shown in FIGS. 1A-3B.

FIGS. 7A and 7B show further perspective views of a partially assembled plant stripper, such as the plant stripper shown in FIGS. 1A-3B.

FIGS. 8A and 8B show further perspective views of a partially assembled plant stripper, such as the plant stripper shown in FIGS. 1A-3B and 7A-7B.

FIGS. 9A and 9B show perspective views of shield cages configured for use on a plant stripper, such as the plant stripper shown in FIGS. 1A-3B and 7A-8B.

FIGS. 10A and 10B show still further perspective views of a partially assembled plant stripper, such as the plant stripper shown in FIGS. 1A-3B and 7A-9B.

FIGS. 11A and 11B show perspective views of a partially assembled angle fitting and an assembled angle fitting configured for use in a plant stripper, such as the plant stripper shown in FIGS. 1A-3B and 7A-10B.

FIGS. 12A and 12B show perspective views of a partially assembled fitting and an assembled fitting configured for use in a plant stripper, such as the plant stripper shown in FIGS. 1A-3B and 7A-10B.

FIGS. 13A and 13B show perspective views of a partially assembled electrical plug fitting and an assembled electrical plug fitting configured for use in a plant stripper, such as the plant stripper shown in FIGS. 1A-3B and 7A-10B.

FIGS. 14A and 14B show perspective views of another partially assembled fitting and the corresponding assembled fitting configured for use in a plant stripper, such as the plant stripper shown in FIGS. 1A-3B and 7A-10B.

FIGS. 14C and 14D show perspective views of yet another partially assembled fitting and the corresponding assembled fitting configured for use in a plant stripper, such as the plant stripper shown in FIGS. 1A-3B and 7A-10B.

FIGS. 15A-15E show further perspective views of a partially assembled plant stripper, such as the plant stripper shown in FIGS. 1A-3B and 7A-10B.

FIGS. 16A-16C show yet further perspective views of a partially assembled plant stripper, such as the plant stripper shown in FIGS. 1A-3B, 7A-10B and 15A-15E.

FIGS. 17A and 17B show further perspective views of a partially assembled plant stripper, such as the plant stripper shown in FIGS. 1A-3B, 7A-10B and 15A-16C.

FIGS. 18A-18C show yet further perspective views of a partially assembled plant stripper, such as the plant stripper shown in FIGS. 1A-3B, 7A-10B and 15A-17B.

FIGS. 19A-19C show further perspective views of a partially assembled plant stripper, such as the plant stripper shown in FIGS. 1A-3B, 7A-10B and 15A-18C.

FIGS. 20A-20C show yet further perspective views of a partially assembled plant stripper, such as the plant stripper shown in FIGS. 1A-3B, 7A-10B and 15A-19C.

FIGS. 21A and 21B show further perspective views of a partially assembled plant stripper, such as the plant stripper shown in FIGS. 1A-3B, 7A-10B and 15A-20C.

FIGS. 22A and 22B show yet further perspective views of an example implementation of a frame of a plant stripper, such as the plant stripper shown in FIGS. 1A-3B, 7A-10B and 15A-21B.

FIGS. 23A and 23B show further perspective views of an example implementation of a partially assembled plant stripper, such as the plant stripper shown in FIGS. 1A-3B, 7A-10B and 15A-22B.

FIGS. 24A and 24B show yet further perspective views of an example implementation of a frame for a plant stripper, such as the plant stripper shown in FIGS. 1A-3B, 7A-10B and 15A-23B.

FIGS. 25A and 25B show yet further perspective views of an example implementation of a partially assembled plant stripper, such as the plant stripper shown in FIGS. 1A-3B, 7A-10B and 15A-24B.

FIGS. 26A and 26B show yet further perspective views of an example implementation of a frame for a plant stripper, such as the plant stripper shown in FIGS. 1A-3B, 7A-10B and 15A-25B.

FIGS. 27A and 27B show yet further perspective views of an example implementation of a partially assembled plant stripper, such as the plant stripper shown in FIGS. 1A-3B, 7A-10B and 15A-26B.

### DETAILED DESCRIPTION

Various implementations of a plant stripper and example assembly views of plant strippers are provided. The plant stripper may be used to strip plant material (e.g., leaves, buds or the like) from other plant material (e.g., stems, trunks, branches, supports or the like). In some implementations, for example, plant strippers may be used to strip one type of plant material from plants such as, but not limited to, hops, hemp and cannabis.

In various implementations, for example, plant stems may be fed though an opening of a sorter plate comprising one or more openings and into one or more rollers adapted to grip and pull the stems through the sorter plate. The opening of the sorter plate is adapted to strip plant material, such as but not limited to, leaves, buds or the like, from the stem (or other plant support material). One or more plant material capture devices are adapted to direct the stripped plant material separated by the sorter plate toward a capture area, such as a bin, drawer or the like, or may direct the stripped plant material toward a secondary processing step, such as but not limited to an extraction system. Where the secondary stage comprises a continuous process stage, a speed of the plant stripper may be adjustable in some implementations to match an input stage of the secondary process system. Example extractions systems include those manufactured by C8 LLC and Espial Biotech, Inc. both located in Washington, U.S. In one example implementation, for example, the stripped plant material is directed toward a conveyor belt or other handling device that directs the stripped material to the secondary processing step. Where the secondary process step comprises a continuous system (e.g., a continuous extraction system), the handling device (conveyor belt or bins or the like) direct the stripped plant material into an input stage (e.g., an input bin) of the secondary stage.

In one example, a motor (e.g., a three-phase motor) has a drive shaft (e.g., a two inch shiv) that holds a V belt (e.g., an “A” sized belt). To provide a soft start to control the speed and start the motor to turn slowly an inverter may be used to control the motor drive frequency (e.g., slow down, speed up, reverse) under control of the inverter. This in turn can be used to stop the machine without damaging the rollers and/or to enable the rollers to be run in reverse.

Speed control, for example, may allow the stripper to accommodate wet or dry plant materials and/or to match upstream or downstream processes (e.g., plant preparation processes and extraction processes).

Dimensions and designs of the plant stripper may assist in moving the stripper and to physically fit through a standard thirty inch doorway.

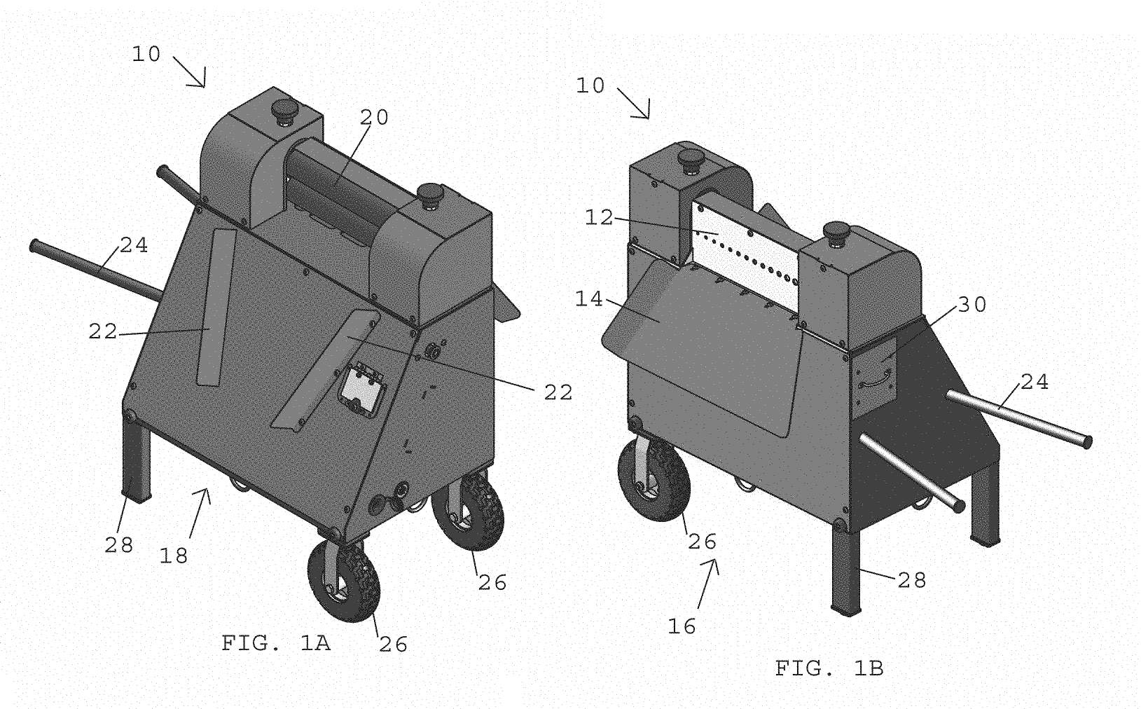

FIGS. 1A and 1B, respectively, show rear perspective (FIG. 1A) and front perspective (FIG. 1B) views of an example implementation of a plant stripper 10. In this implementation, the plant stripper comprises a sorter plate 12, a harvesting chute 14 shown on a front side 16 of the plant stripper 10. Shown on a rear side 18, the plant stripper 10 comprises at least one roller 20 adapted to engage a stem, trunk, branch or other support structure of a plant received through the sorter plate 12 and pull the support structure through the sorter plate 12 thereby stripping plant material from the support structure via the sorter plate 12. In the particular implementation shown in FIG. 1A, for example, the at least one roller 20 comprises a pair of adjustable rollers 20 adapted to engage plant support materials directed through the sorter plate 12.

The sorter plate 12, in various implementations, includes one or more openings for receiving the plant support structure for engagement with the one or more rollers 20. In one example implementation, such as shown in FIG. 1B, the opening(s) may vary in size for handling different sized plant material. Further, the plurality of openings, in this implementation, are adapted for receiving multiple plants simultaneously. For example, a plurality of operators may prep and feed plants through the plant stripper at the same time.

A discharge chute, generally designated 22, may be defined by a pair of flanges such as shown in FIG. 1A and is adapted to direct discharged plant support materials away from the at least one roller 20, whether for disposal or for further processing.

In various implementations, the plant stripper 10 may be further adapted to be movable such as via handles 24 (fixed or telescoping) and wheels 26, casters, rollers or the like. In the particular implementation shown in FIGS. 1A and 1B, for example, the plant stripper 10 comprises legs 28 and wheels 26. An operator may grasp the handles 24 and lift the legs like a wheelbarrow and move the plant stripper through a shop or other facility. The plant stripper 10 may be moved between locations where plants have been prepped for processing. In other implementations, the plant stripper may be stationary even though the particular example shows wheels.

The plant stripper 10, in this implementation, further comprises a drawer 30, chute or the like disposed below the at least one roller 20 for capturing or directing shake or other stripped plant material to reduce waste from a plant stripping operation. Although a drawer is shown in FIGS. 1A and 1B, a slanted opening, chute or other device may direct the shake or other plant material to a common or separate receptacle, such as a bin, conveyor or the like.

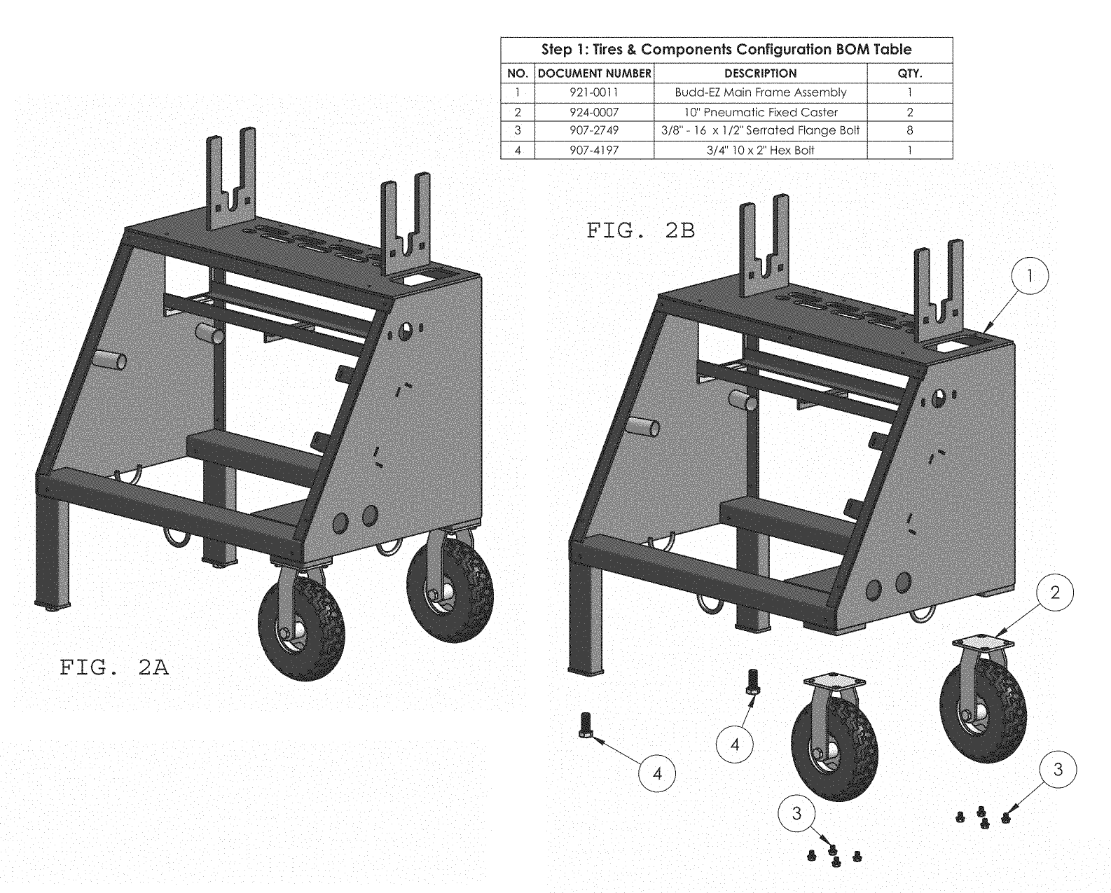

FIGS. 2A and 2B show perspective views of the plant stripper 10 shown in FIGS. 1A and 1B in a partially assembled configuration. In FIGS. 2A and 2B, an example frame 40 for the plant stripper is shown. In this particular example, a main frame assembly 2-1 supports wheels, casters, rollers or the like, such as pneumatic fixed casters 2-2 shown in FIGS. 2A and 2B. The casters are coupled to the frame 2-1, in this implementation, via a plurality (e.g., four) of bolts 2-3 each. Bolts 2-4 may also be provided at the bottom of legs to allow for a height adjustment. (For simplicity, the reference numbers x-y (e.g., 2-1, 2-2, 2-3 and 2-4) refer to reference items shown in FIGS. 2A and 2B).

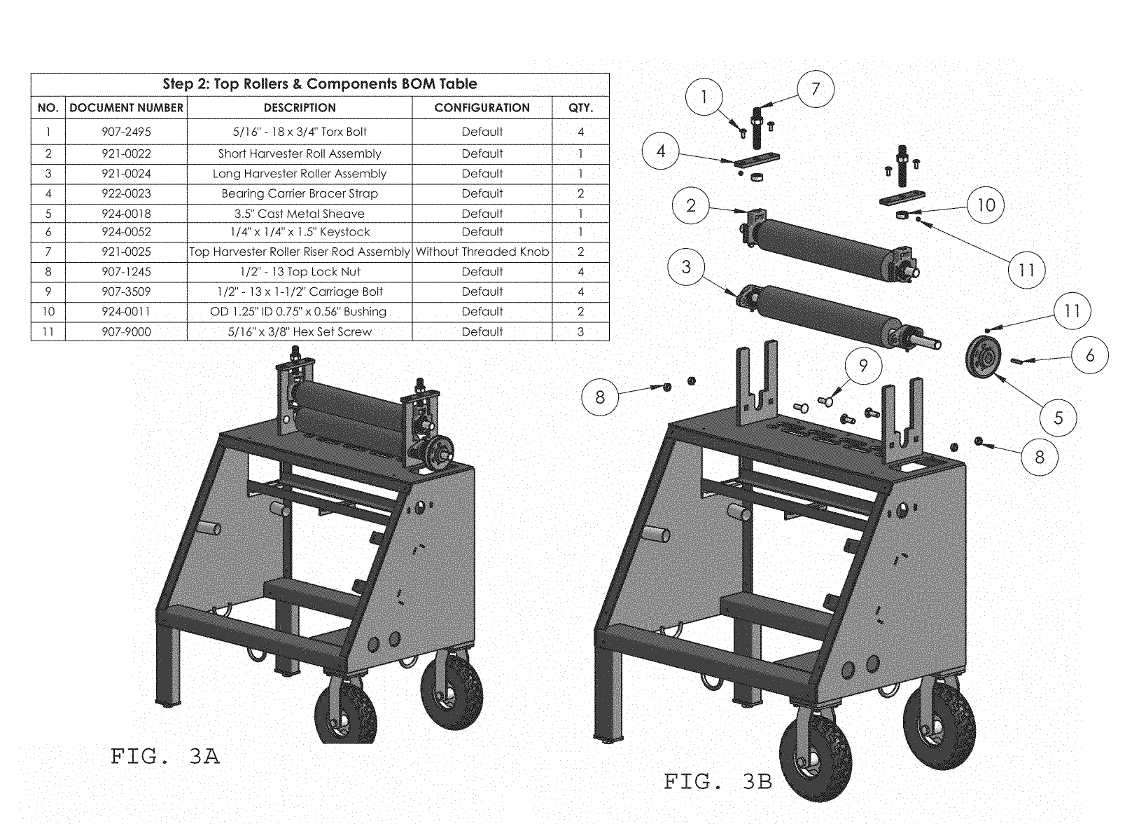

FIGS. 3A and 3B show further perspective views of the plant stripper 10 shown in FIGS. 1A, 1B, 2A and 2B in a partially assembled configuration. In the implementation shown in FIGS. 3A and 3B, for example, a pair of rollers comprising an adjustable opening are mounted to the frame 2-1 via a pair of brackets comprising one or more openings adapted for receiving and supporting the rollers. In this particular implementation, the pair of rollers comprises a short harvester roller 3-2 and a long harvester roller 3-3. In this example, the rollers 3-2 and 3-3 are oriented in a generally horizontal configuration defining a generally horizontal nip or opening between the rollers adapted to receive plant supports (e.g., stems, trunks, branches or the like) through the sorter plate 12 shown in FIG. 1B. The roller assemblies 3-2 and 3-2 are coupled to the frame bracket via bolts 3-1, straps 4-4, roller riser rod assemblies 3-7, lock nuts 3-8, bushings 3-10, and set screws 3-11. In this particular example, a height of the upper roller 3-2 (or a relative position of the two rollers 3-2 and 3-3 are adjustable to change the size of the nip or opening between the rollers via the roller riser rod assembly described in more detail herein. Various implementations of riser rod assemblies include ones with handles and without handles such that the roller height or separation may be adjusted without removing a protective cover or other portion of the plant stripper. A sheave 3-5 (e.g., a metal sheave) is coupled to one of the roller assemblies (e.g., long harvester roller assembly 3-3), such as via set screw 3-11 and keystock 3-6.

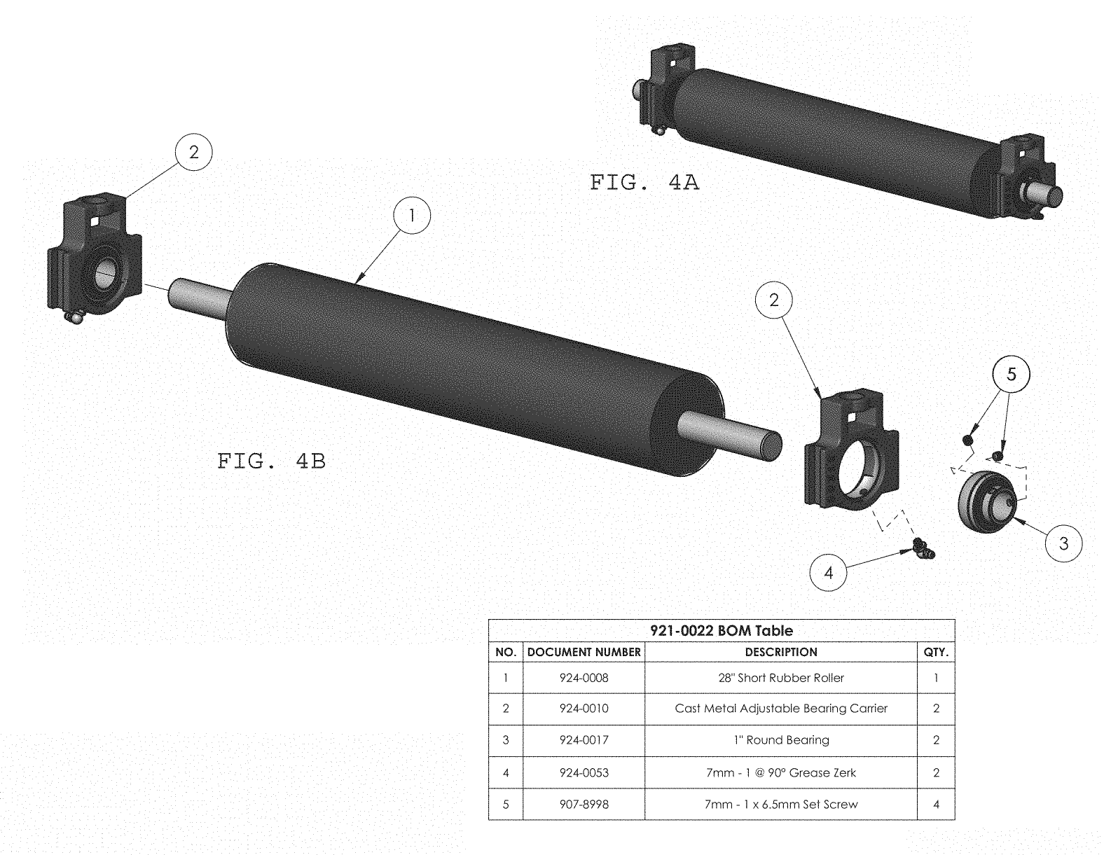

FIGS. 4A and 4B show perspective views of an assembled roller device of a plant stripper 10, such as shown in FIGS. 1A-3B and an unassembled roller device of the plant stripper 10, respectively. In this example, short harvester roller assembly 3-2 (shown in FIGS. 3A and 3B) comprises a roller 4-1 (e.g., a rubber roller, rubber coated roller or other type of roller adapted to grip a support structure of a plant of interest). The roller 4-1 is coupled to an adjustable bearing carrier 4-2 and bearing 4-3 via one or more set screws 4-5. A grease zerk 4-4 is provided in this example in the bearing carrier to allow for the roller assembly to be lubed.

FIGS. 5A and 4B show perspective views of an assembled roller device of a plant stripper 10, such as shown in FIGS. 1A-3B, and an unassembled roller device of the plant stripper 10, respectively. In this example, long harvester roller assembly 3-3 (shown in FIGS. 3A and 3B) comprises a roller 5-1 (e.g., a rubber roller, rubber coated roller or other type of roller adapted to grip a support structure of a plant of interest). The roller 5-1 is coupled to a stationary bearing carrier 5-2 and bearing 5-4 via one or more set screws 5-5. A grease zerk 5-3 is provided in this example in the bearing carrier to allow for the roller assembly to be lubed.

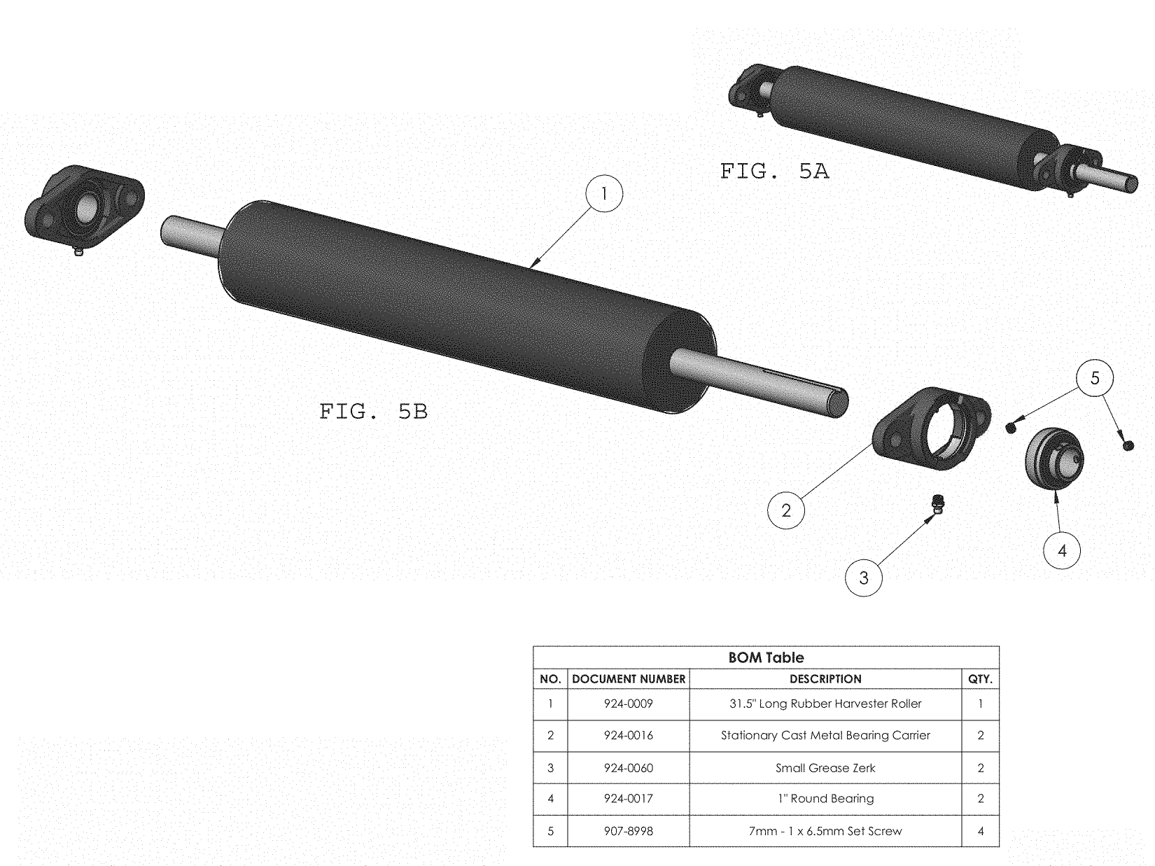

FIG. 6 shows example implementations of a roller riser assembly for a plant stripper, such as the plant stripper 10 shown in FIGS. 1A-3B. In various example implementations, the assembly may comprise a knob 6-4 (FIGS. 6B and 6C) or may not comprise a knob (FIG. 6A). The assembly, in these examples, comprises a threaded rod 6-1, a hex nut 6-2 and a lock washer 6-3. Where the know extends above a protective shield, such as shown in FIGS. 1A and 1B, for example, the knob allows easy adjustment of the top roller assembly to change the dimension of the nip or opening between the rollers. In other implementations, a protective cover may be removed (if present) to allow adjustment of the roller assemblies. These are merely example confugrations; other implementations are also contemplated.

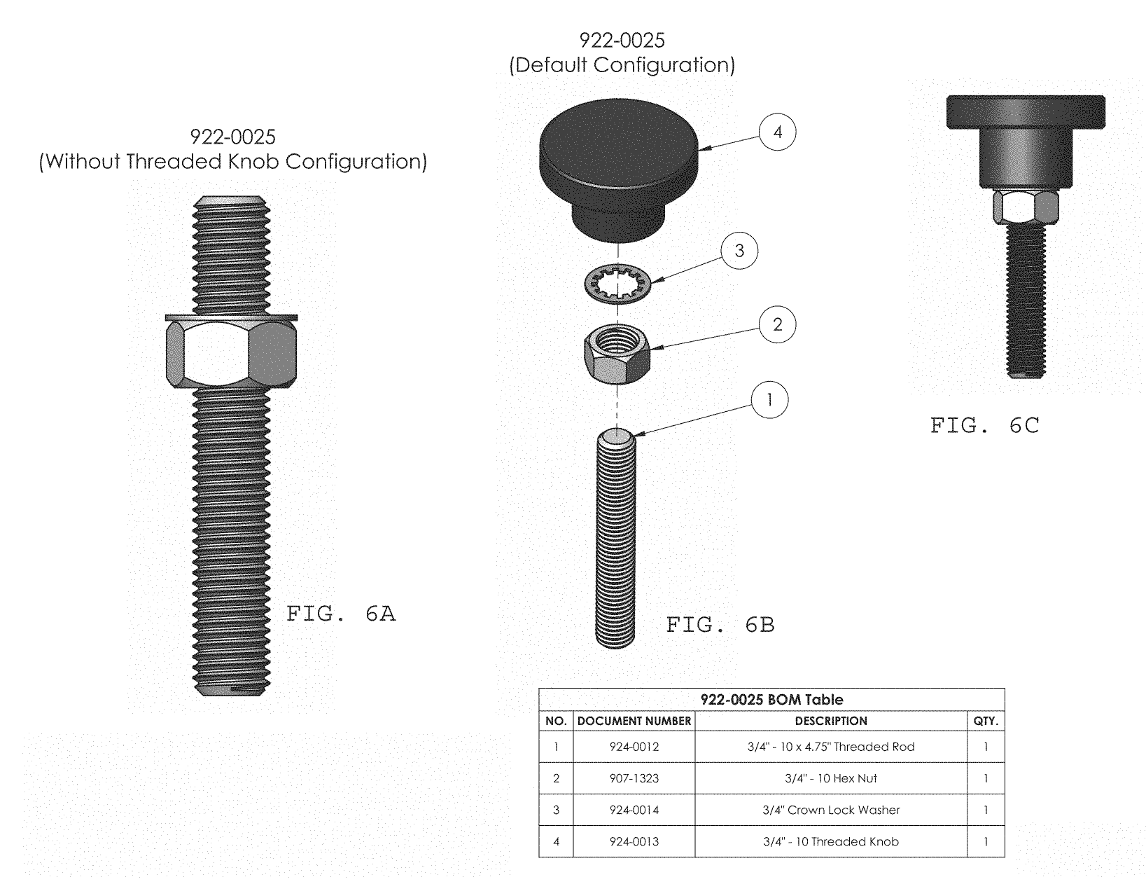

FIGS. 7A and 7B show further perspective views of a partially assembled plant stripper, such as the plant stripper 10 shown in FIGS. 1A-3B. In the particular example shown in FIGS. 7A and 7B, a motor 7-3 is coupled to the frame via a motor plate assembly 7-1 and is coupled to the roller assembly via a belt 7-2 and a motor sheave 7-5 and set screw 7-13. A tensioner spring 7-4 is coupled via a carriage bolt 7-12, washers 7-6 and nut 7-7. The motor 7-3 is coupled to the plate 7-1 via one or more bolts 7-11 and nuts 7-10. A bolt 7-8 and nut 7-9, in this example, couples the motor plate 7-1 to the frame

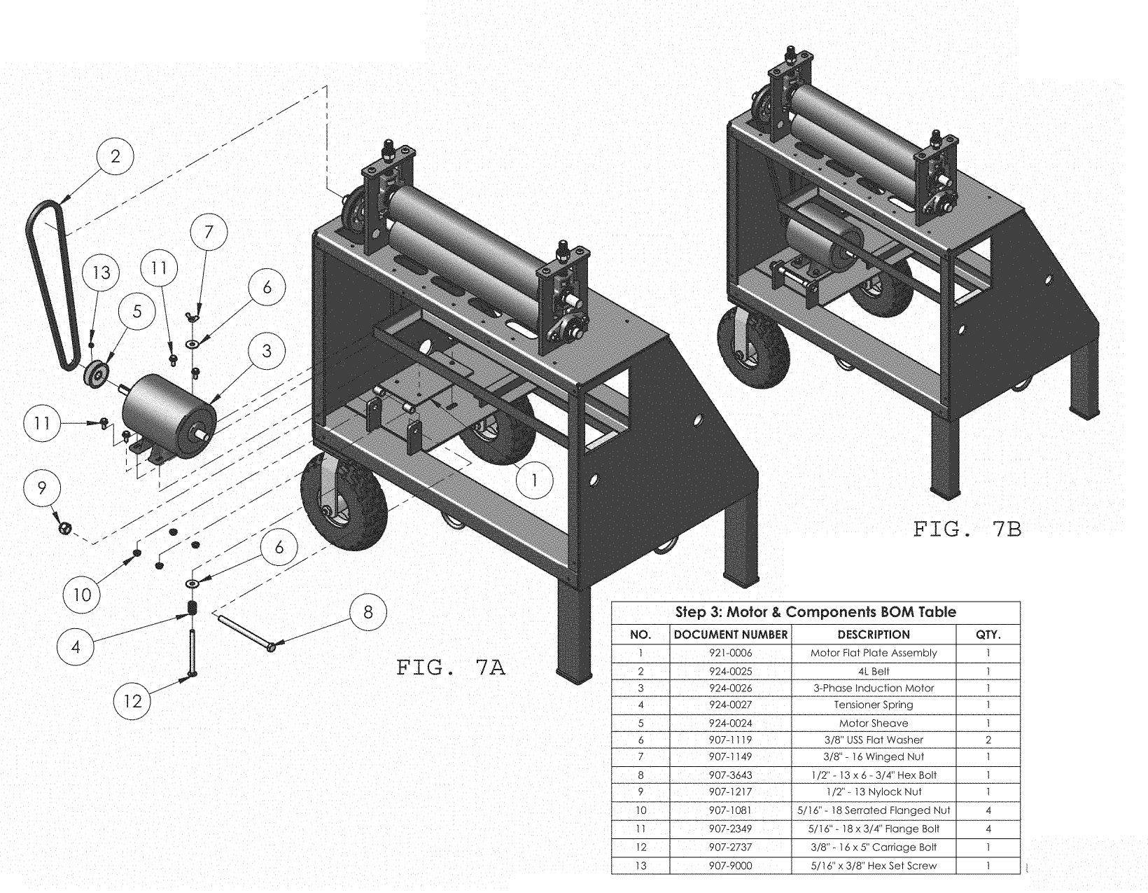

FIGS. 8A and 8B show further perspective views of a partially assembled plant stripper, such as the plant stripper 10 shown in FIGS. 1A-3B and 7A-7B. In this particular example, shield cages or covers 8-2, 8-3, 8-4 and 8-5 are coupled to the plant stripper, such as via one o more bolts or screws 8-. In this particular implementation, knob 8-6, such as described in more detail herein, may extend beyond the protective cages or covers to enable roller adjustment (e.g., roller height adjustment).

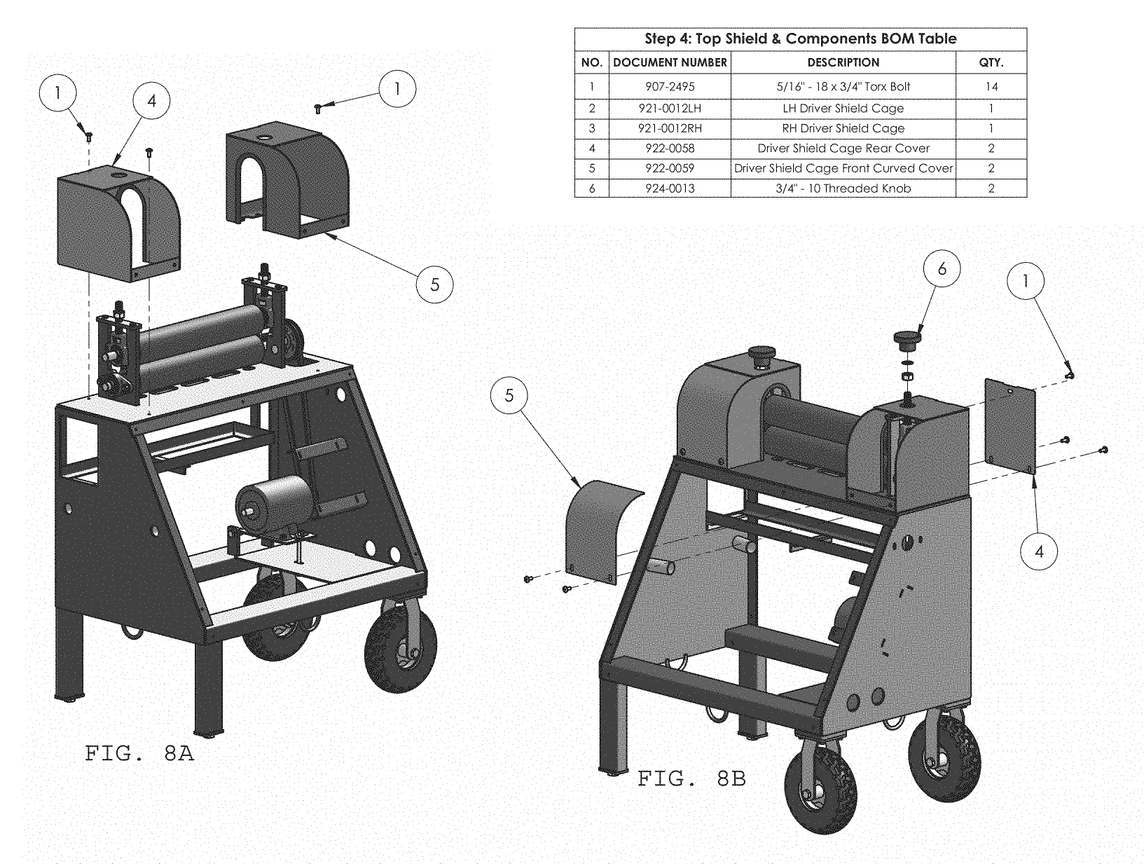

FIGS. 9A and 9B show perspective views of example implementations of protective shield cages or covers configured for use on a plant stripper, such as the plant stripper 10 shown in FIGS. 1A-3B and 7A-8B. In various implementations, for example, surfaces may be protected via one or more protector strips or gaskets 9-2.

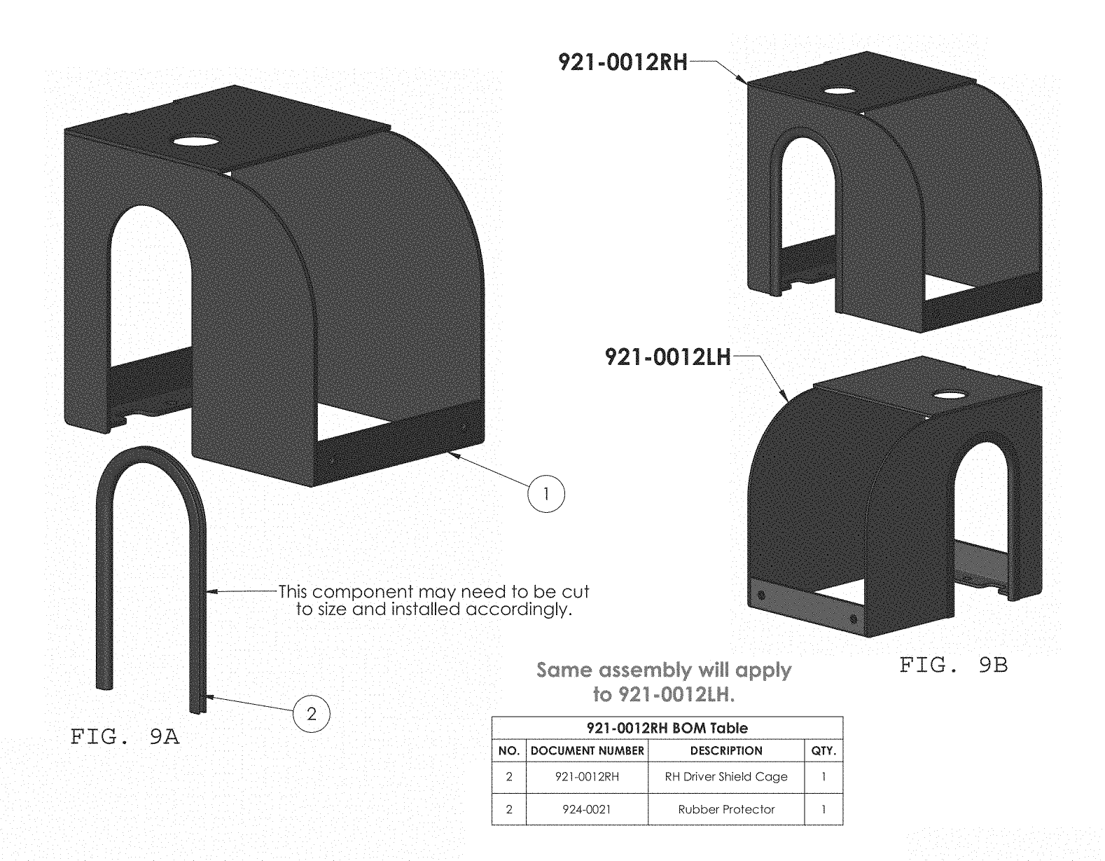

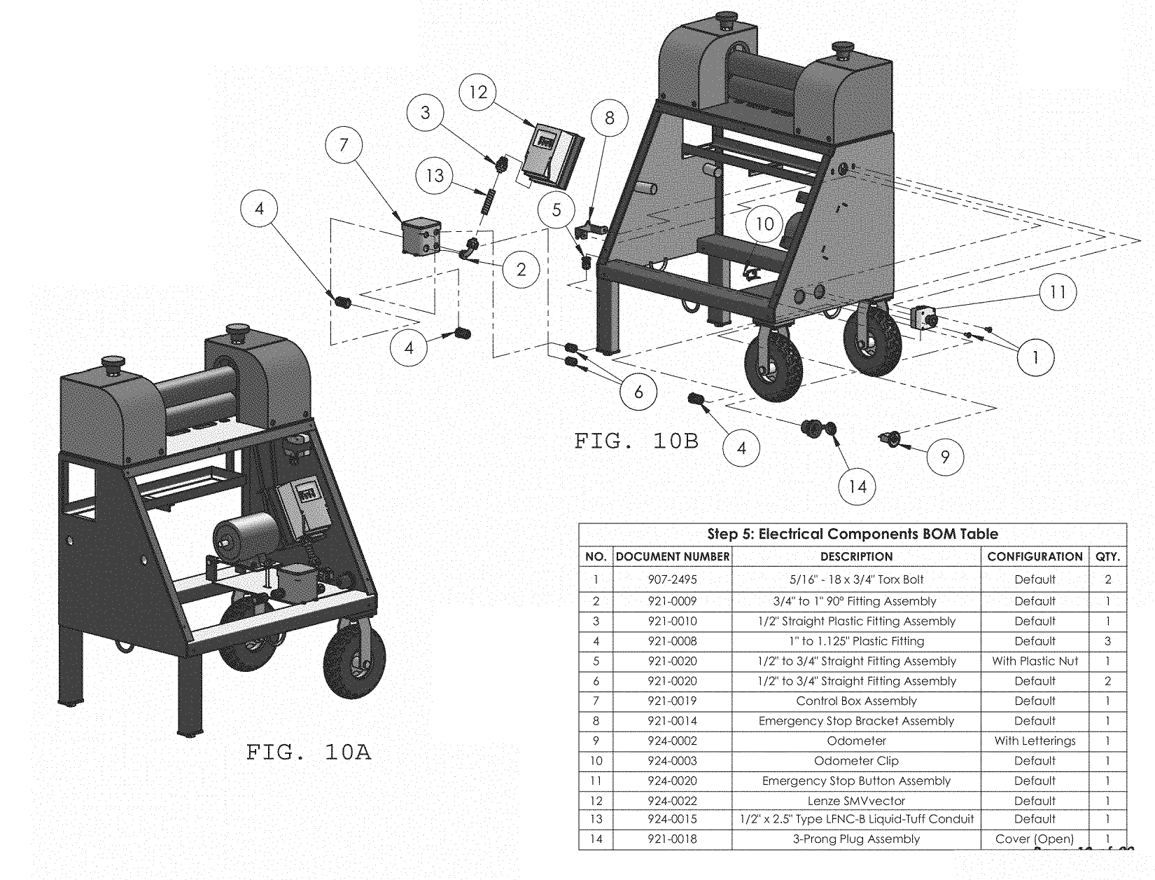

FIGS. 10A and 10B show still further perspective views of a partially assembled plant stripper, such as the plant stripper 10 shown in FIGS. 1A-3B and 7A-9B. In this particular example, the plant stripper comprises a control box assembly 10-7, an emergency stop button assembly 10-11 secured to the plant stripper frame via an emergency stop bracket assembly 10-8, an odometer 10-9 secured to the plant stripper frame via an odometer clip 10-10, an inverter 10-12 coupled to the motor, and an electrical plug assembly 10-14. Various wires and connectors are connected to the various components via one or more fittings, fitting assemblies and conduits, such as shown in FIGS. 10A and 10B as well as FIGS. 11A through 14D.

FIGS. 11A and 11B show perspective views of a partially assembled angle fitting and an assembled angle fitting configured for use in a plant stripper, such as the plant stripper shown in FIGS. 1A-3B and 7A-10B.

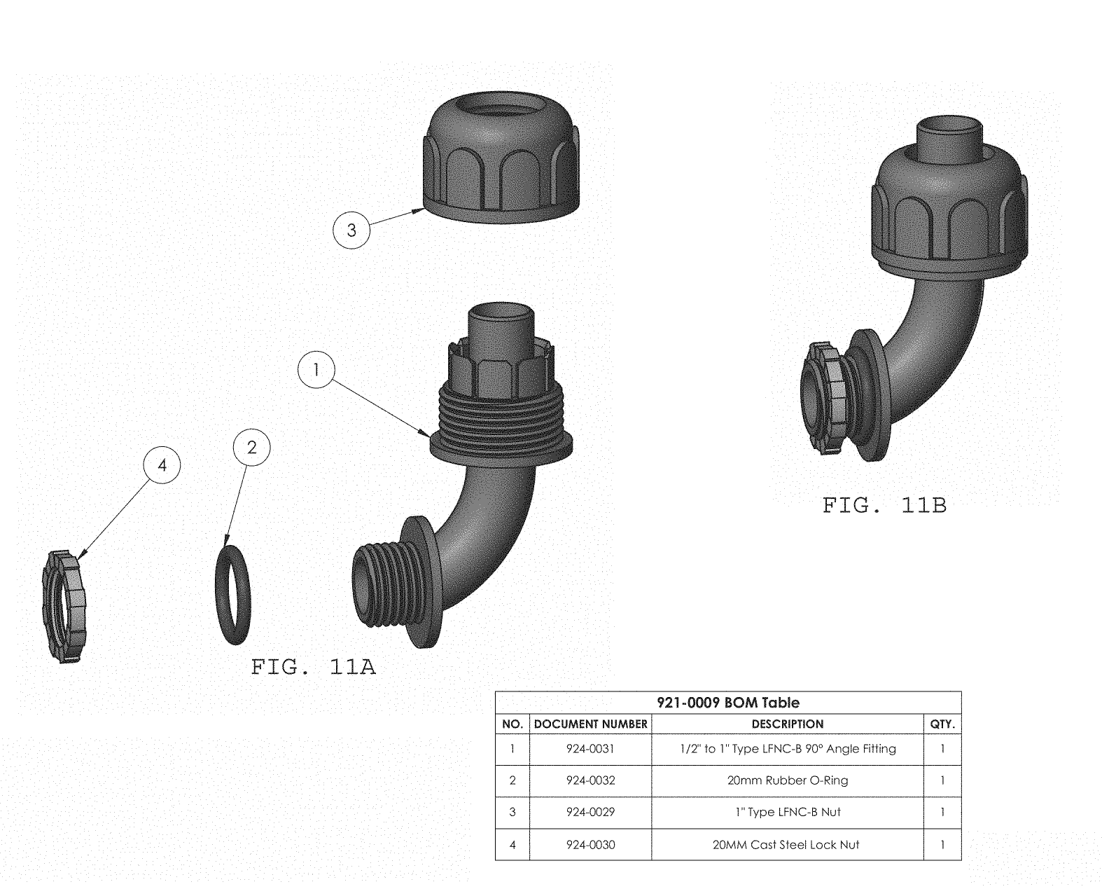

FIGS. 12A and 12B show perspective views of a partially assembled fitting and an assembled fitting configured for use in a plant stripper, such as the plant stripper shown in FIGS. 1A-3B and 7A-10B.

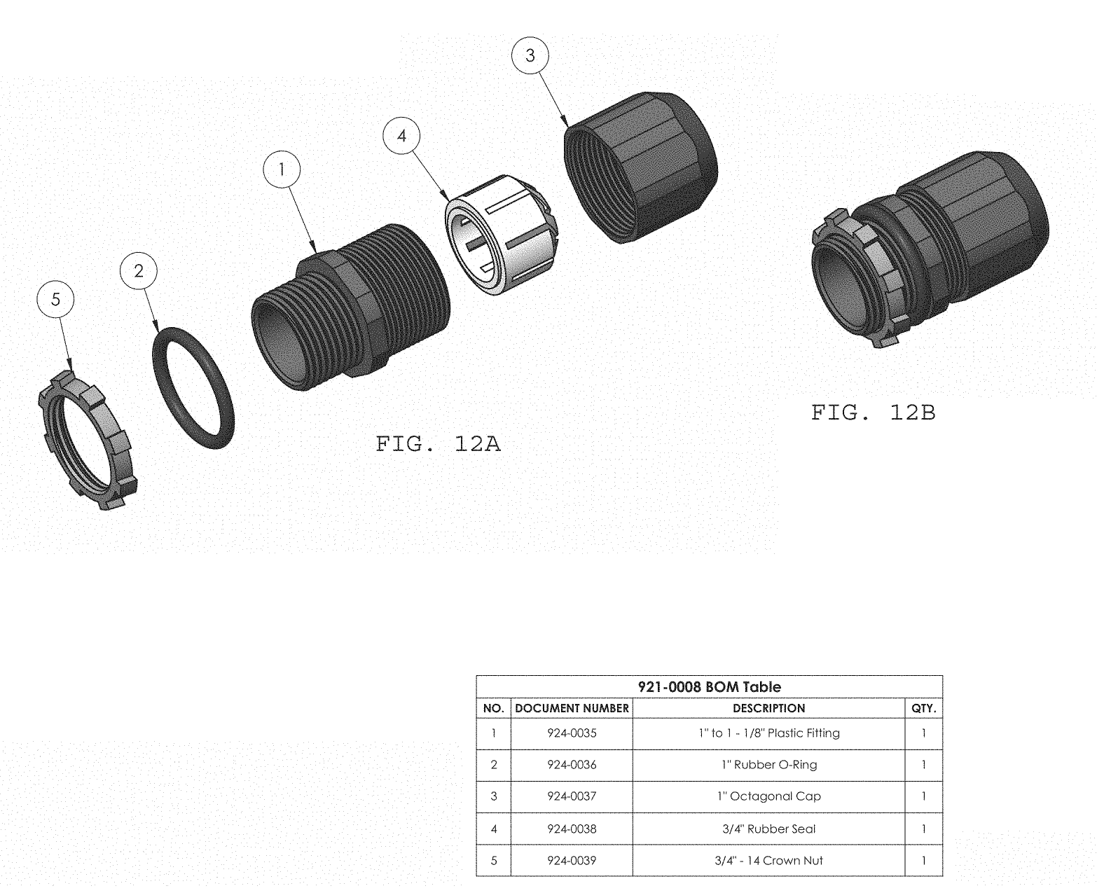

FIGS. 13A and 13B show perspective views of a partially assembled electrical plug fitting and an assembled electrical plug fitting configured for use in a plant stripper, such as the plant stripper shown in FIGS. 1A-3B and 7A-10B.

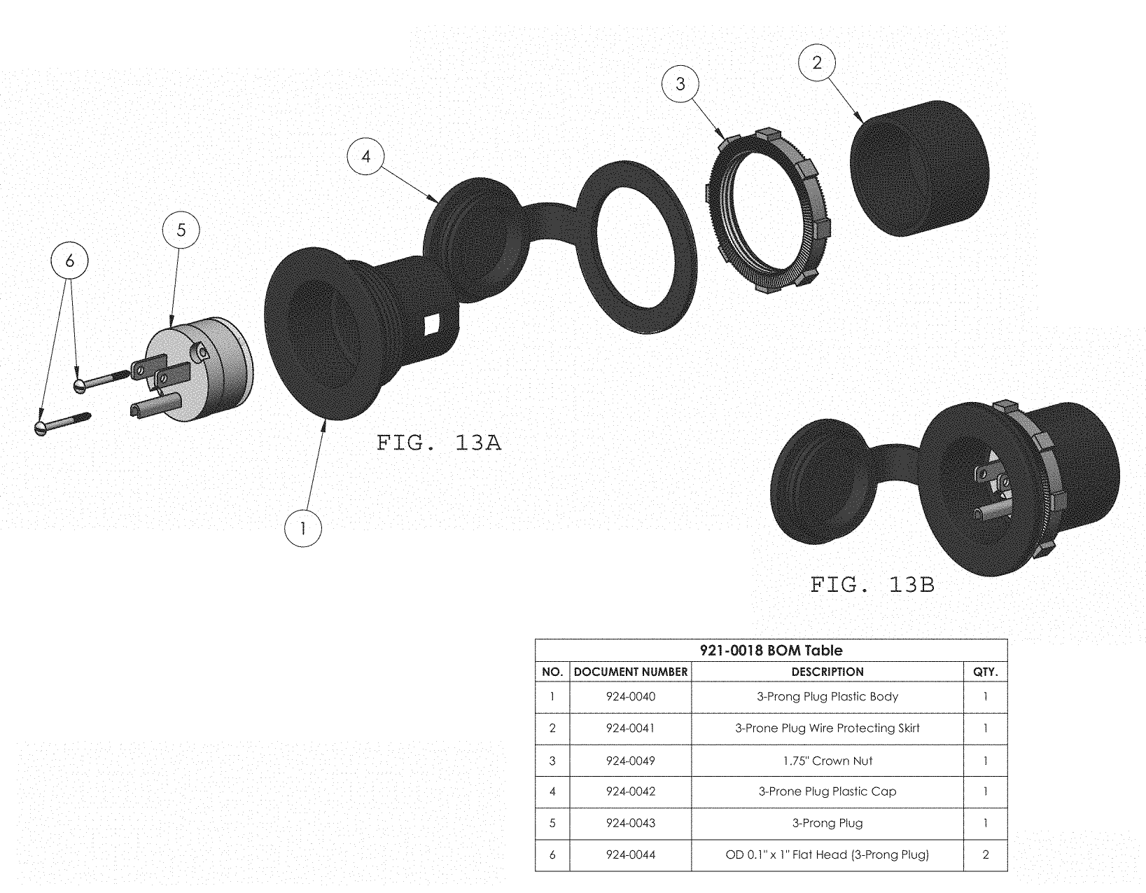

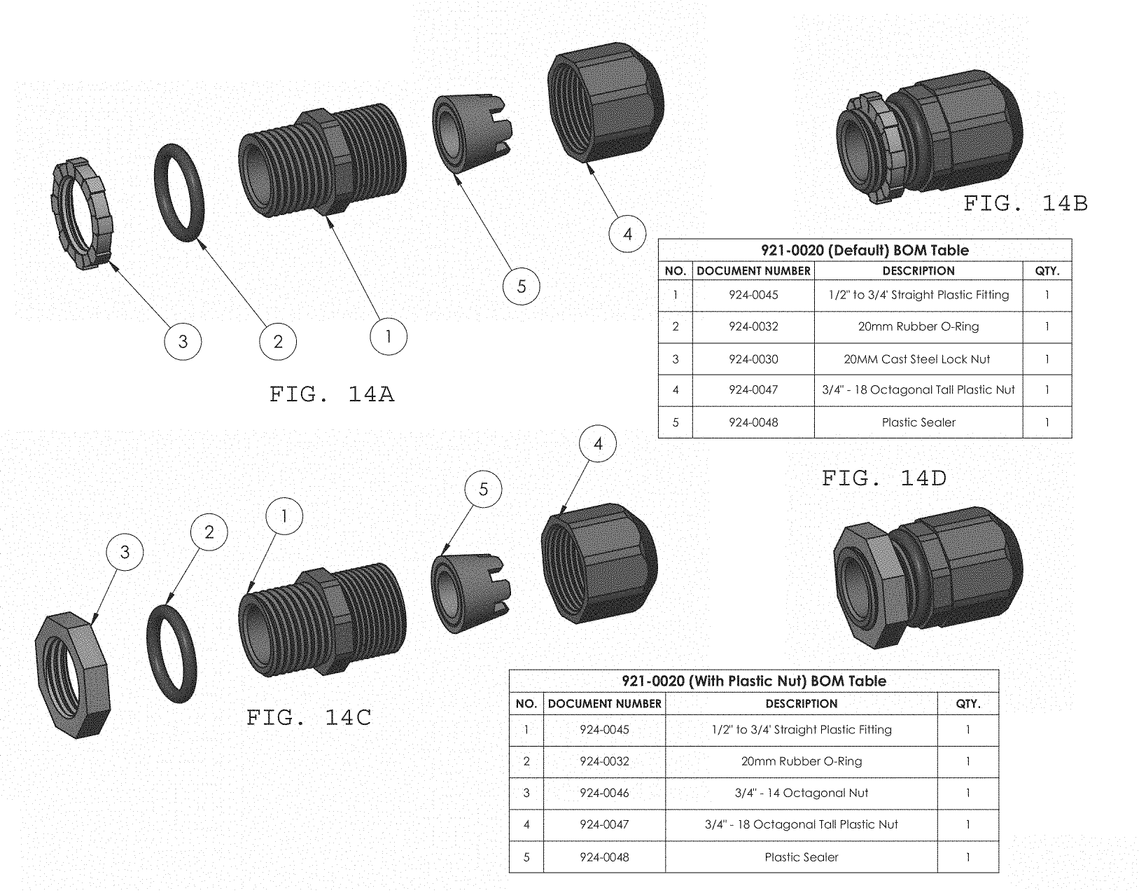

FIGS. 14A and 14B show perspective views of another partially assembled fitting and the corresponding assembled fitting configured for use in a plant stripper, such as the plant stripper shown in FIGS. 1A-3B and 7A-10B.

FIGS. 14C and 14D show perspective views of yet another partially assembled fitting and the corresponding assembled fitting configured for use in a plant stripper, such as the plant stripper shown in FIGS. 1A-3B and 7A-10B.

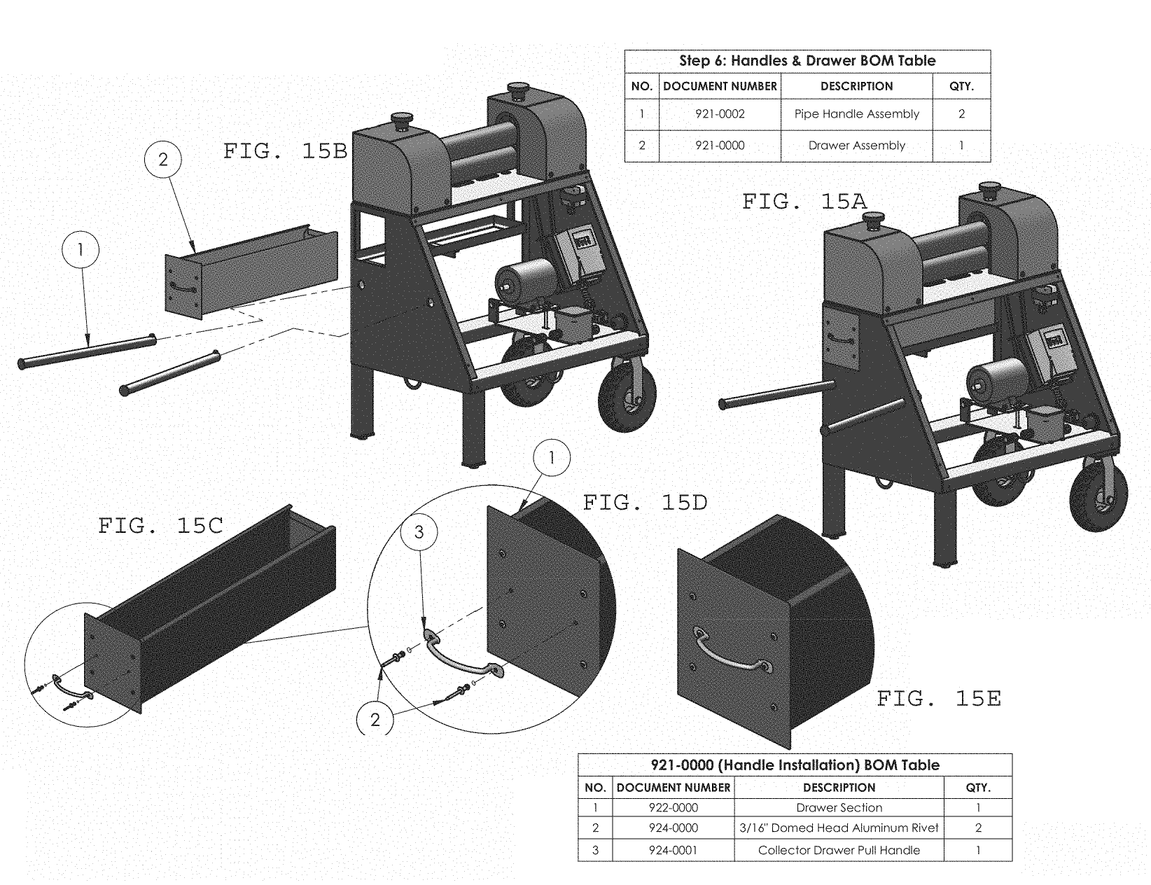

FIGS. 15A-15E show further perspective views of a partially assembled plant stripper, such as the plant stripper shown in FIGS. 1A-3B and 7A-10B. In particular, FIG. 15A shows the partially assembled view with the components shown attached to a frame of the plant stripper. FIG. 15B shows an exploded view in which a drawer assembly and handle assembly are shown with reference to the plant stripper frame. FIGS. 15C-15E show close up partial views of the drawer assembly 15-2 in which a drawer section 15D-1 is coupled to a pull handle 15D-3 via one or more rivets 15D-2 or other connectors.

As discussed herein, the drawer is disposed under or near the roller assembly such that shake or other plant material not captured via the sorter plate may be captured to reduce overall waste.

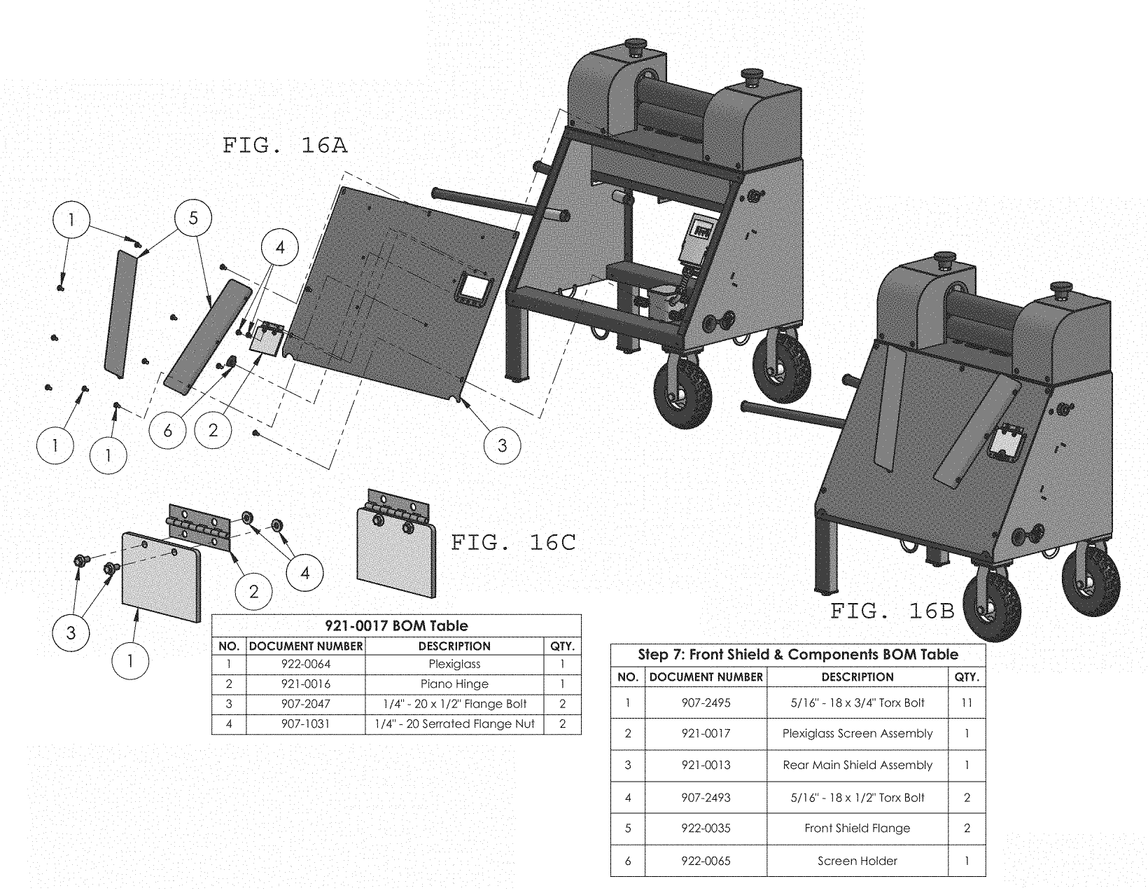

FIGS. 16A-16C show yet further perspective views of a partially assembled plant stripper, such as the plant stripper shown in FIGS. 1A-3B, 7A-10B and 15A-15E. In this particular example, the plant stripper comprises an exit chute defined by a pair of flanges 16-5 coupled to and extending from a main shield assembly 16-3, such as via one or more bolts 16-1, screws, rivets or other connectors. The chute is adapted to direct plant support structures that have had plant material stripped from them away from the roller assembly and stripper plate. In this example, a screen assembly 16-2 (e.g., plexiglass screen assembly) is disposed in the main shield assembly away from the chute and coupled thereto via one or more bolt 16-4, screw, rivet or other connector, and screen holder 16-6. The screen assembly 16-6, for example, may comprise a screen 16-6-1 (e.g., plexiglass screen), a hinge 16-6-2, one or more bolt 16-6-3 and nut 16-6-4 or other connector.

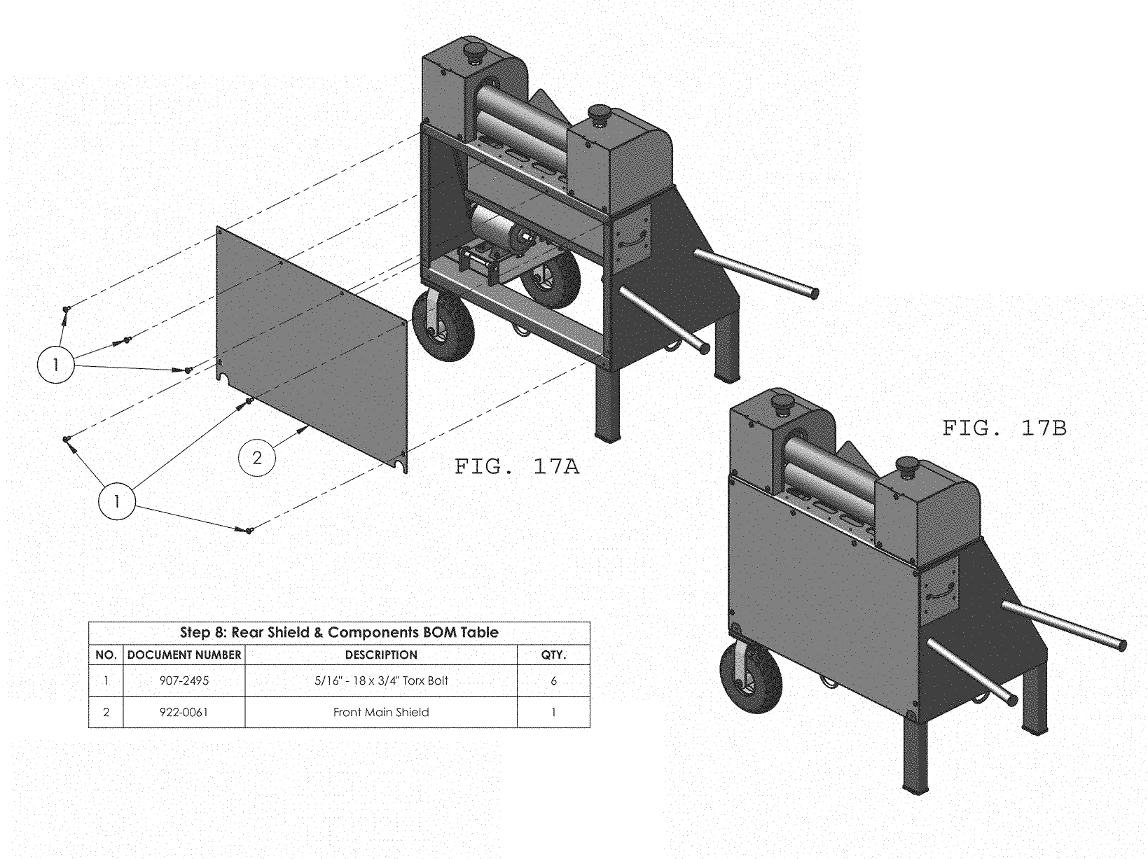

FIGS. 17A and 17B show further perspective views of a partially assembled plant stripper, such as the plant stripper shown in FIGS. 1A-3B, 7A-10B and 15A-16C. In this example, a shield 17-2 is coupled to the frame of the plant stripper via one or more connector, such as bolt 17-1.

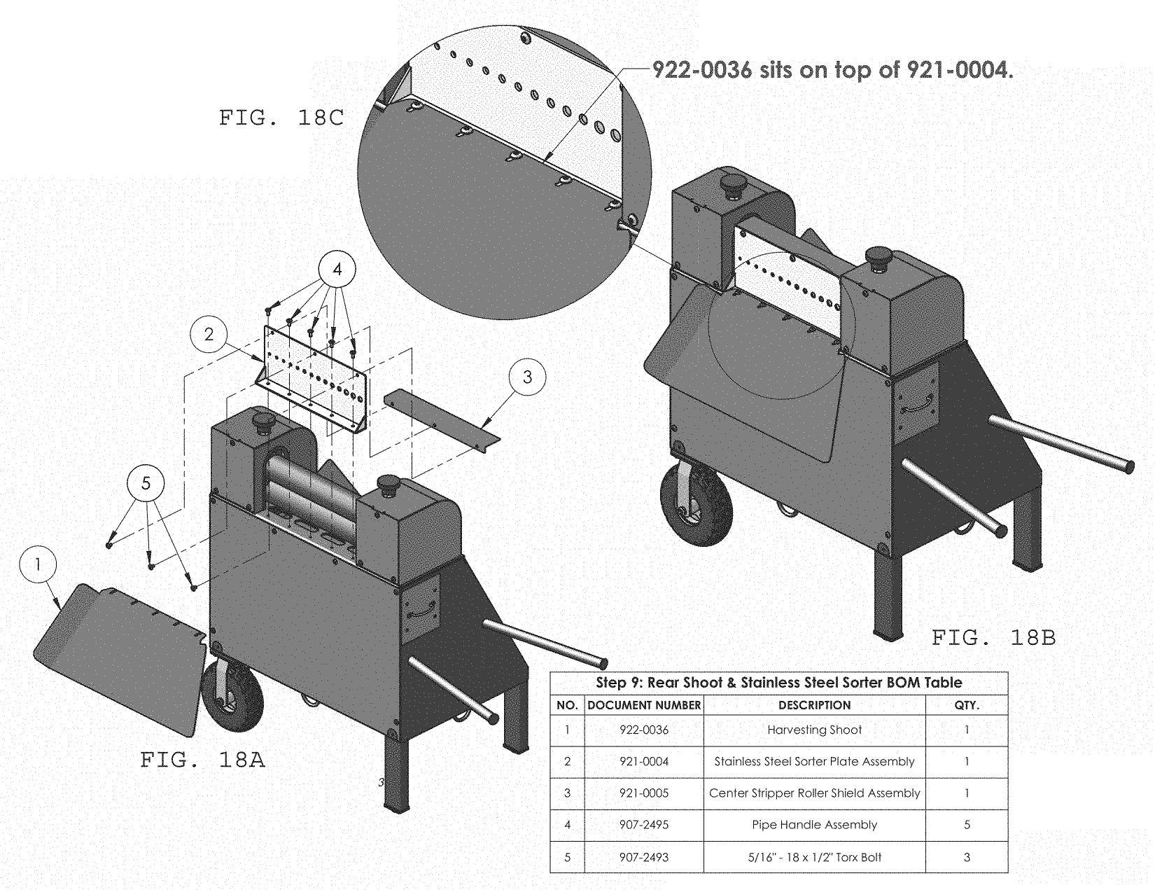

FIGS. 18A-18C show yet further perspective views of a partially assembled plant stripper, such as the plant stripper shown in FIGS. 1A-3B, 7A-10B and 15A-17B. In this particular example, the plant stripper comprises a sorter plate assembly 18-2 comprising a sorter plate including one or more openings adapted to receive a support structure of a plant to be stripped (e.g., a stem, trunk, branch or the like), such as described in more detail herein. A harvesting chute 18-1 is coupled to the frame and is adapted to receive stripped plant material from the sorter plate. A shield assembly 18-3 shields the roller assembly. Each of the assemblies may be coupled to the frame or other components of the plant stripper via one or more connectors, such as but not limited to bolts 18-5. As shown in FIGS. 18A-18C, slits in the chute are adapted to couple the chute plate to the sorter plate assembly, such as via one or more connectors 18-4. Openings (shown in FIG. 18-A), may be disposed under the roller assembly to allow further shake or other plant material to drop into the drawer assembly described herein.

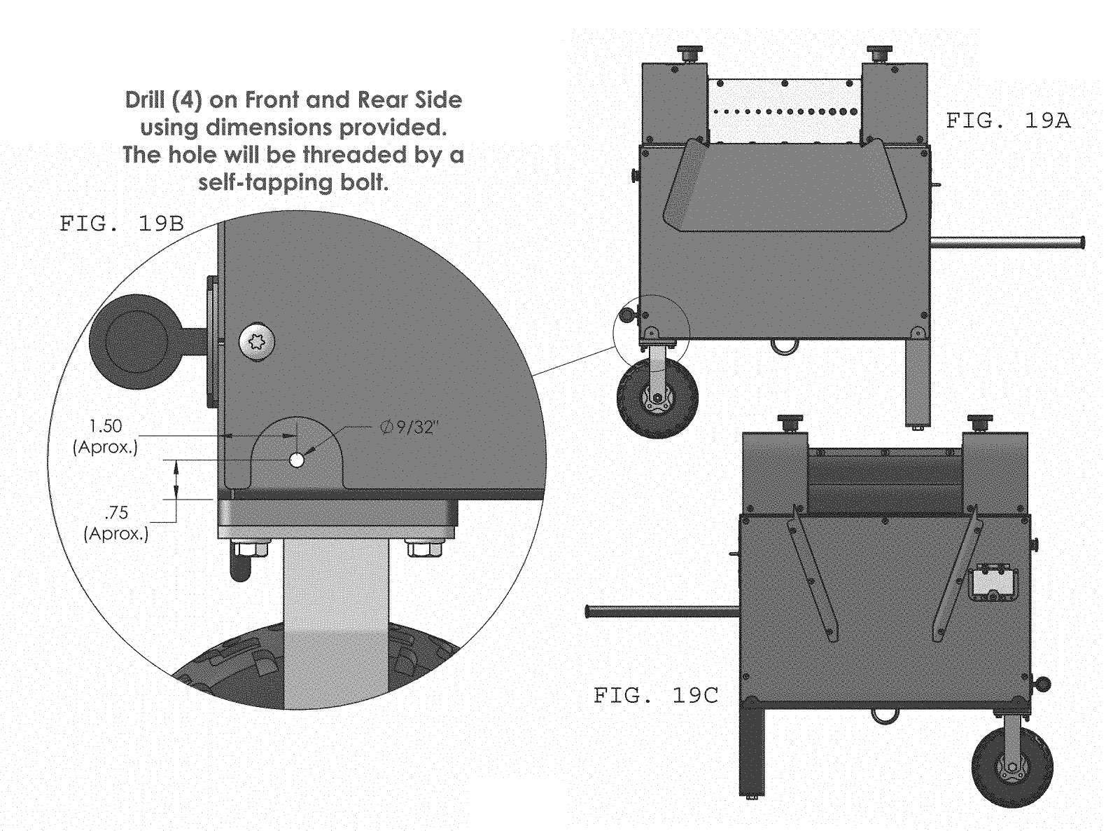

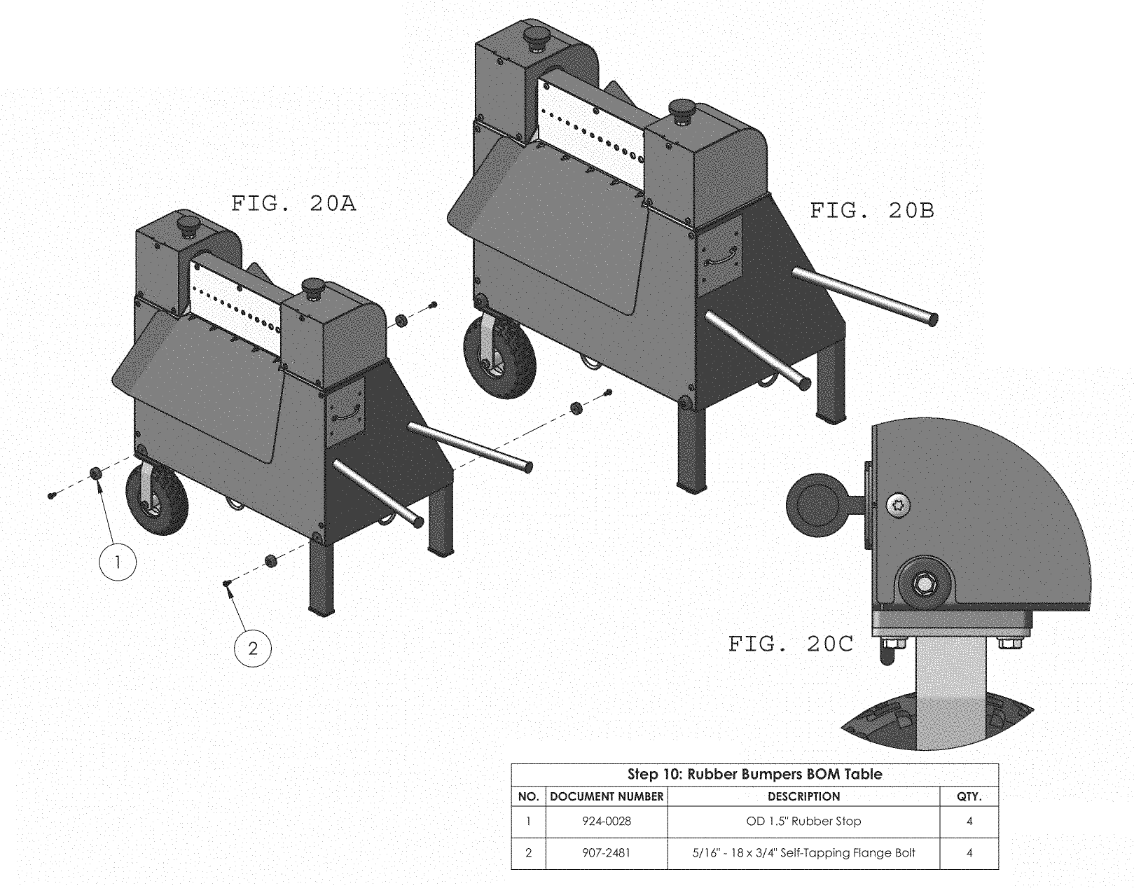

FIGS. 19A-19C show further perspective views of a partially assembled plant stripper, such as the plant stripper shown in FIGS. 1A-3B, 7A-10B and 15A-18C. FIGS. 20A-20C show yet further perspective views of a partially assembled plant stripper, such as the plant stripper shown in FIGS. 1A-3B, 7A-10B and 15A-19C. In this particular example, casters, rollers or other wheels and legs are coupled to the frame of the plant stripper via one or more connectors, such as one or more bolts 20-2 and stops 20-1.

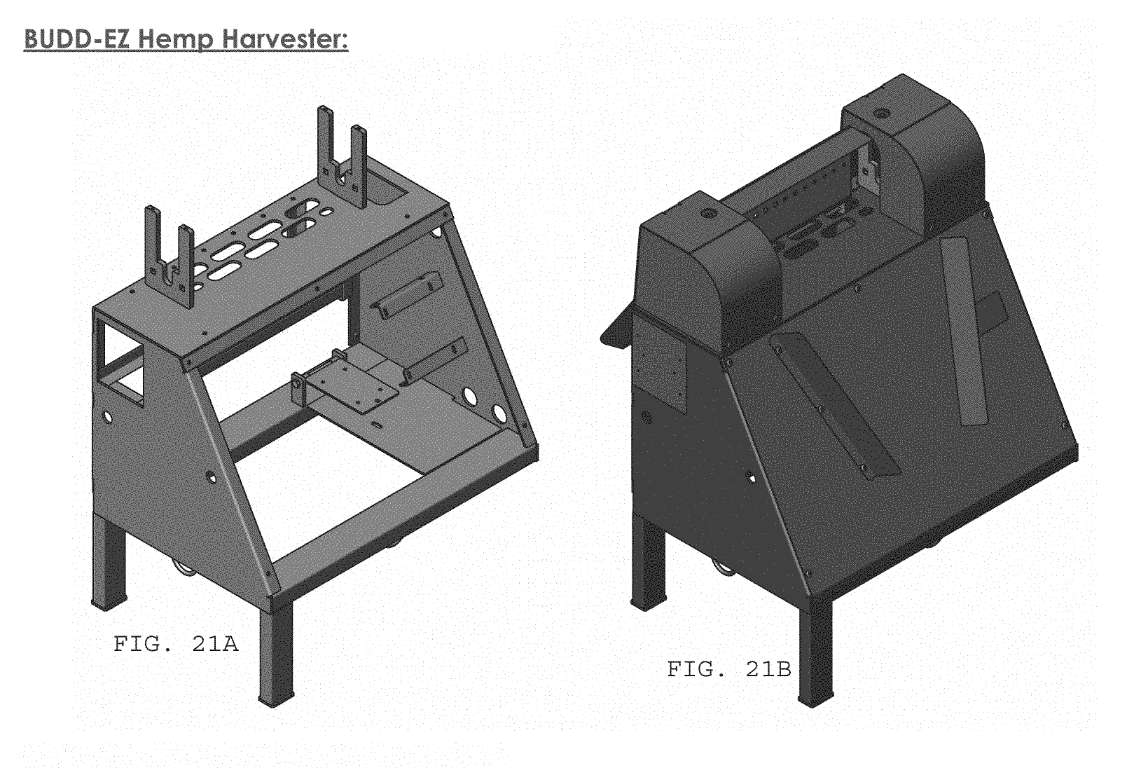

FIGS. 21A and 21B show further perspective views of a partially assembled plant stripper, such as the plant stripper shown in FIGS. 1A-3B, 7A-10B and 15A-20C.

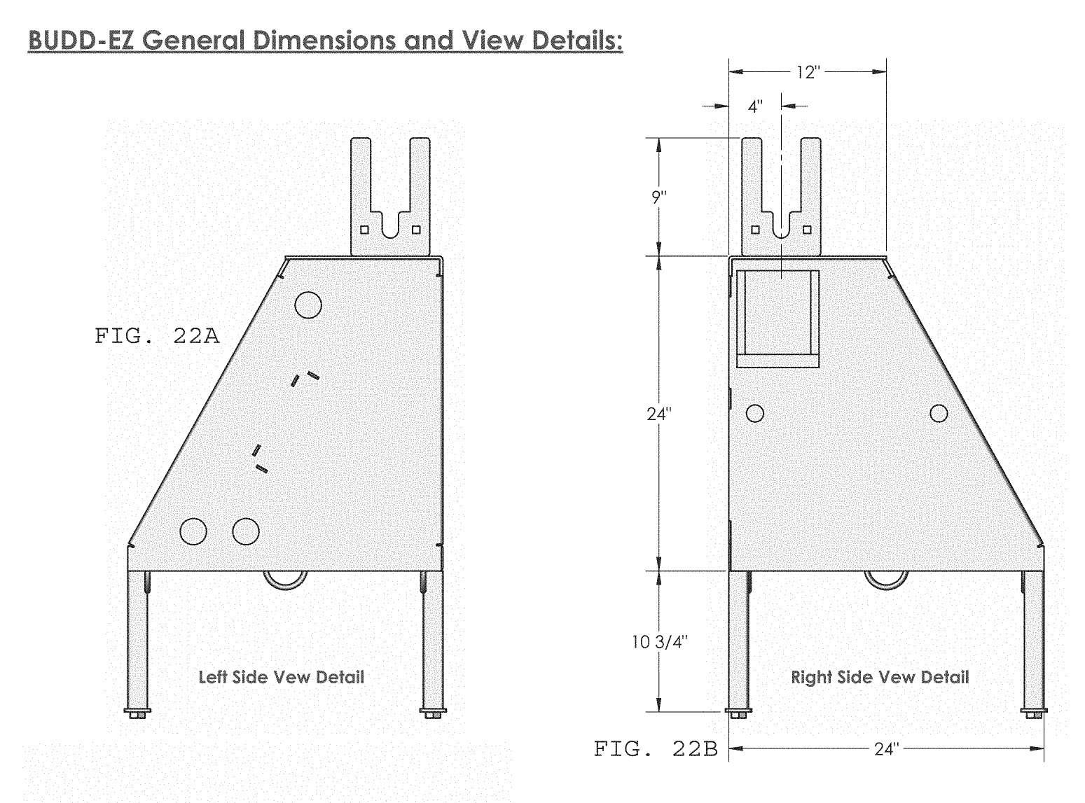

FIGS. 22A and 22B show yet further perspective views of an example implementation of a frame of a plant stripper, such as the plant stripper shown in FIGS. 1A-3B, 7A-10B and 15A-21B. In particular, example dimensions of one example implementation of the plant stripper are shown in right side and left side views of a frame of a plant stripper.

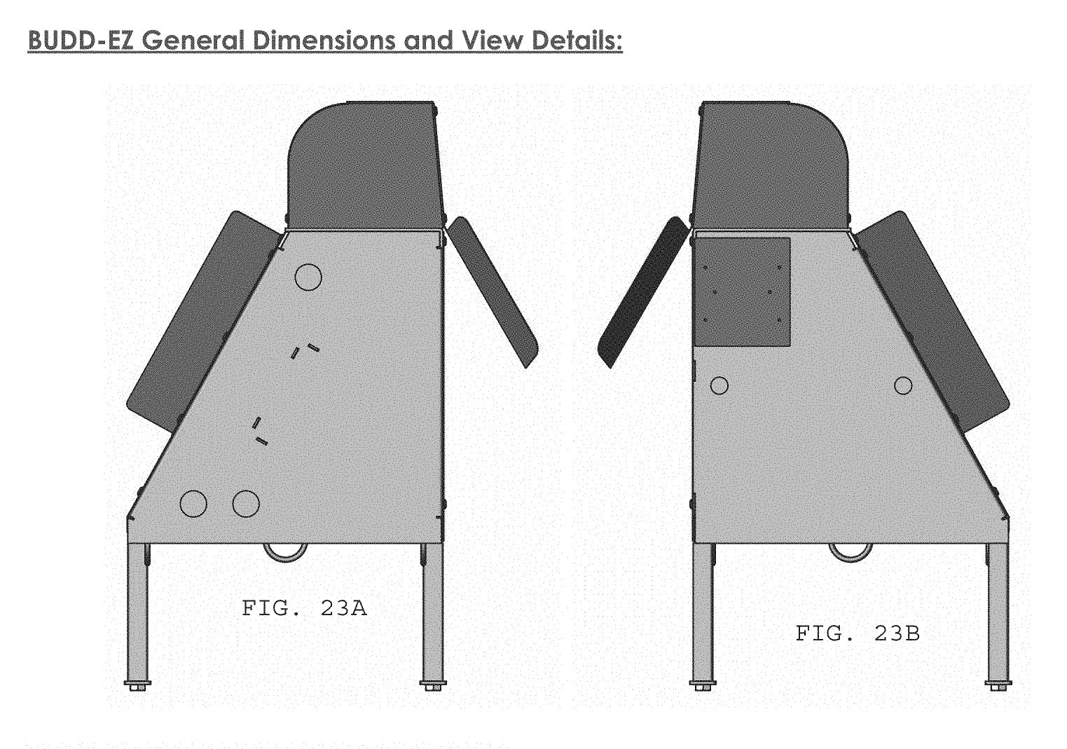

FIGS. 23A and 23B show further perspective views of an example implementation of a partially assembled plant stripper, such as the plant stripper shown in FIGS. 1A-3B, 7A-10B and 15A-22B.

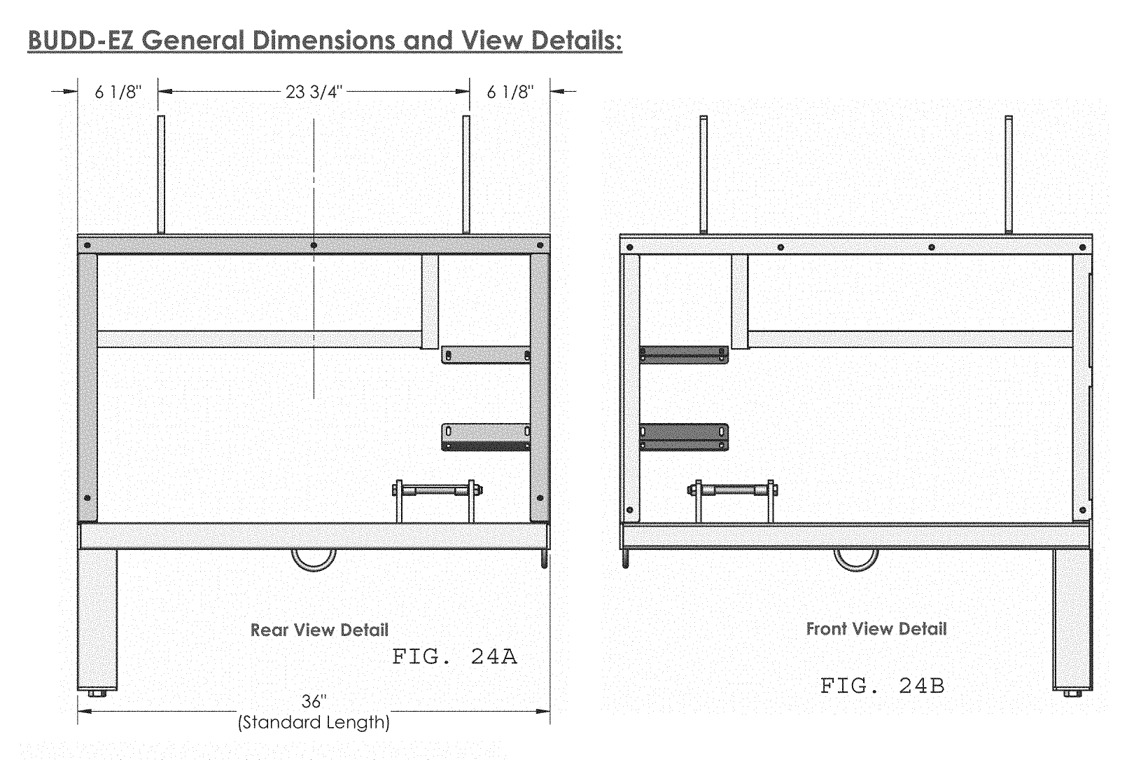

FIGS. 24A and 24B show yet further perspective views of an example implementation of a frame for a plant stripper, such as the plant stripper shown in FIGS. 1A-3B, 7A-10B and 15A-23B. In particular, rear and front detail views of an example implementation of a frame of a plant stripper are shown with example dimensions.

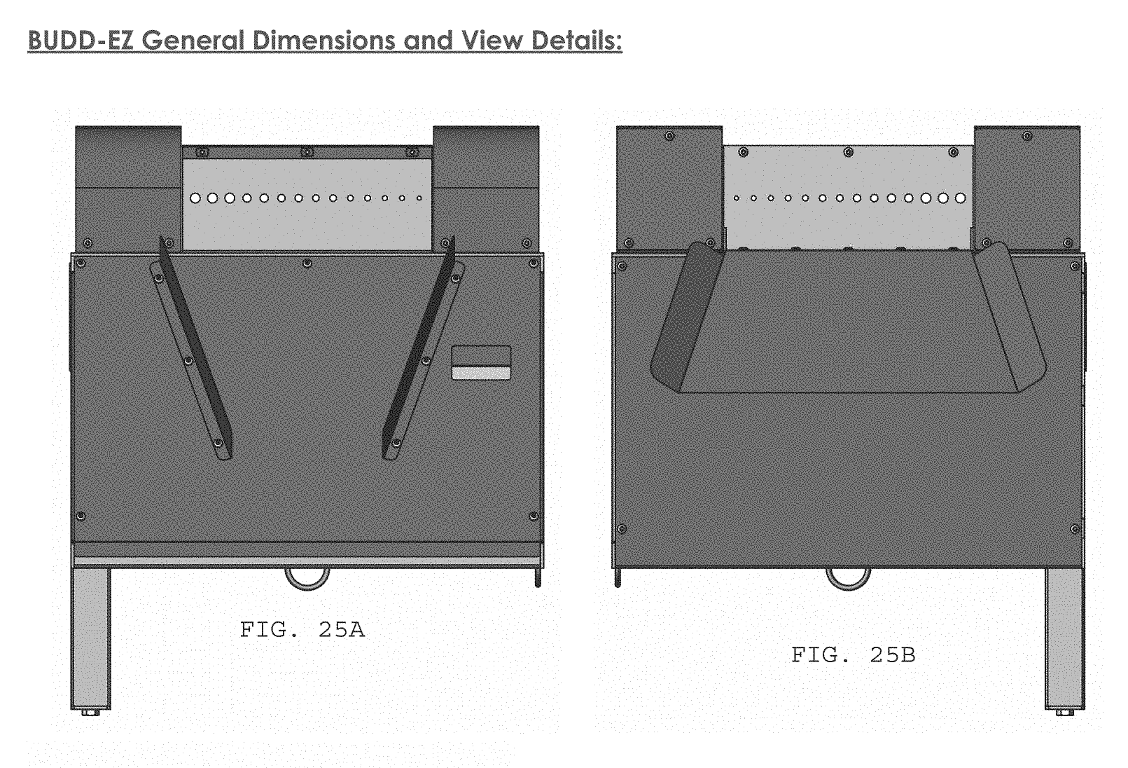

FIGS. 25A and 25B show yet further perspective views of an example implementation of a partially assembled plant stripper, such as the plant stripper shown in FIGS. 1A-3B, 7A-10B and 15A-24B.

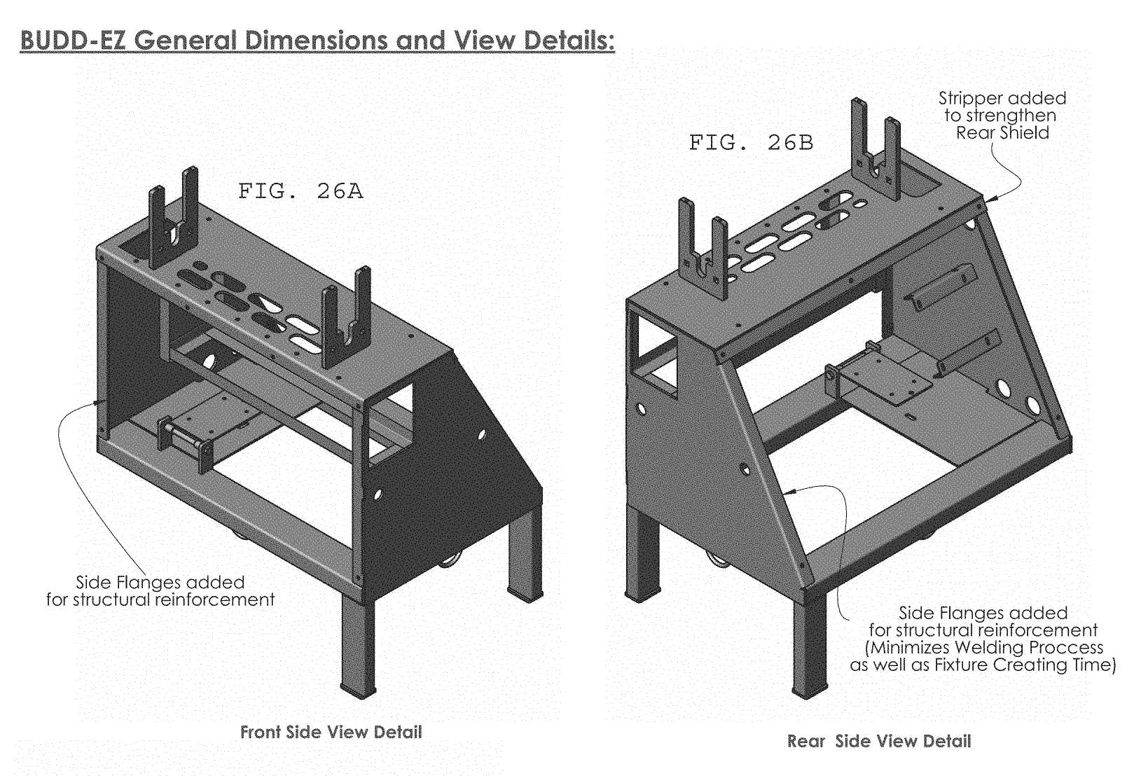

FIGS. 26A and 26B show yet further perspective views of an example implementation of a frame for a plant stripper, such as the plant stripper shown in FIGS. 1A-3B, 7A-10B and 15A-25B. In this particular example, flanges are added to a plant stripper frame for added structural reinforcement. In one particular implementation, for example, the flanges may provide reinforcement without added welding processes and can also reduce assembly time.

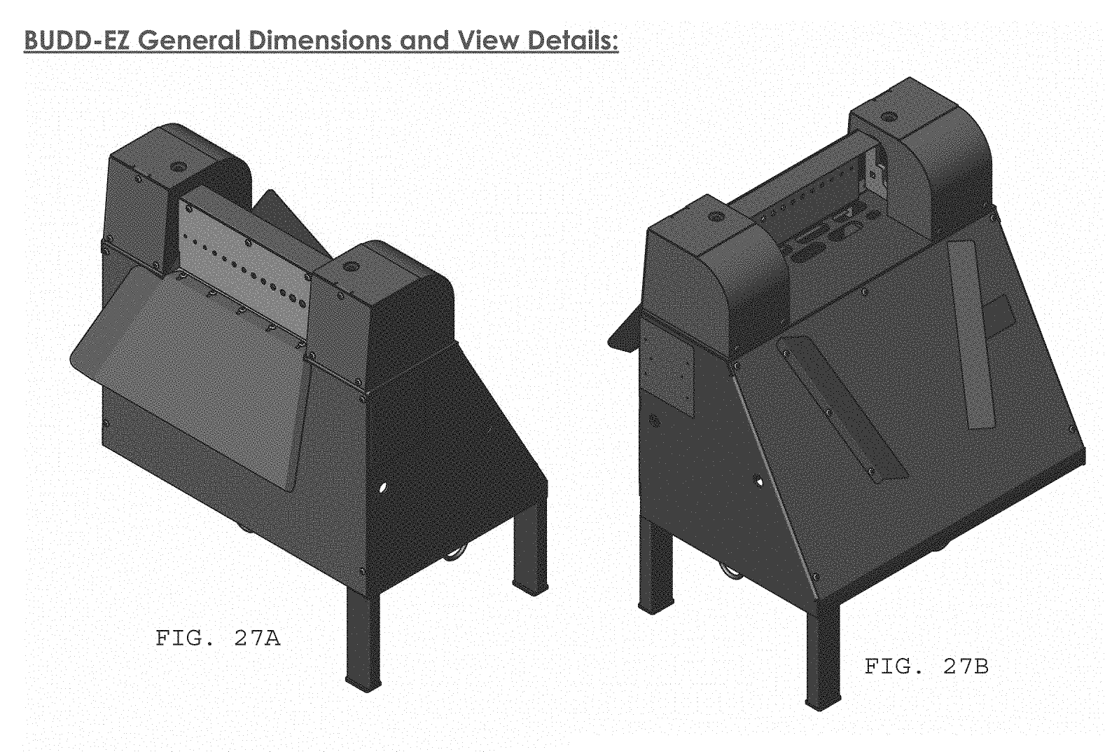

FIGS. 27A and 27B show yet further perspective views of an example implementation of a partially assembled plant stripper, such as the plant stripper shown in FIGS. 1A-3B, 7A-10B and 15A-26B.

The foregoing and other aspects, features, details, utilities, and advantages of the present invention will be apparent from reading the following description and claims, and from reviewing the accompanying drawings.

Although implementations have been described above with a certain degree of particularity, those skilled in the art could make numerous alterations to the disclosed embodiments without departing from the spirit or scope of this invention. In various drawings, for example, specific hardware is shown of particular example implementations. However, other combinations of hardware are envisioned that may be used to couple components of the plant strippers, adjust positions of the plant stripper components or may replace example components of the plant strippers described herein (e.g., chutes, capture drawers, receptacles or the like). Further, although two rollers are shown in the drawings, a single roller disposed opposing another surface may also be used to pull the plant support materials through the plant stripper devices. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A plant stripper comprising:
a motor comprising a drive shaft;
a first roller coupled to the drive shaft and configured to be turned by the motor;
a second roller opposing the first roller and defining a gap between the rollers for receiving a stem of a plant;
a stripping guide element defining an opening disposed opposite the gap between the first and second roller, the opening defined by a surface surrounding the opening and configured to contact plant material while allowing the stem to pass through the opening, wherein the surface is configured to remove plant material from the stem as the stem is pulled through the opening by the first and second rollers.

2. The plant stripper of claim 1 wherein the motor comprises a three phase motor.

3. The plant stripper of claim 2 wherein the motor is coupled to an inverter.

4. The plant stripper of claim 1 wherein a speed of the motor is variable.

5. The plant stripper of claim 4 wherein the speed of the motor is variable to match a processing speed of a second downstream processing step.

6. The plant stripper of claim 4 wherein the speed of the motor is variable to match a processing speed of an upstream processing step.

7. The plant stripper of claim 3 wherein the speed of the motor is adjustable to accommodate wet or dry plant material.

8. The plant stripper comprising a handle, a pair of legs and a pair of wheels coupled to a frame.

9. The plant stripper of claim 8 wherein the pair of legs are adjustable.

10. The plant stripper of claim 8 wherein the handle comprise a pair of telescoping handle bars extending from the frame opposite the wheels.

11. The plant stripper of claim 1 wherein the openings are adapted to strip plant material from at least one of a hop plant, a hemp plant and a cannabis plant.

12. The plant stripper of claim 1 wherein the stripping guide element comprises a sorter plate comprising at least one opening.

13. The plant stripper of claim 12 wherein the sorter plate comprises a plurality of openings.

14. The plant stripper of claim 13 wherein the plurality of openings comprise different size openings.

15. The plant stripper of claim 13 wherein the plurality of openings comprise the same size openings.

16. A method of stripping plant material from a plant support, the method comprising:
feeding a plant support through an opening of a sorter plate to at least one roller;
drawing the plant support through the opening via the at least one roller;
stripping the plant material from the plant support via the sorter plate; and
collecting the plant material from the sorter plate.
